(19) United States
(12) Patent Application Publication
(10) Pub. No.: US 2017/0336643 A1
(43) Pub. Date: Nov. 23, 2017

(54) DISPLAY PANEL AND ELECTRONIC DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Pengcheng LU, Beijing (CN); Xue DONG, Beijing (CN); Renwei GUO, Beijing (CN); Xi CHEN, Beijing (CN); Chungchun CHEN, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/326,414

(22) PCT Filed: Aug. 17, 2015
(86) PCT No.: PCT/CN2015/087202

§ 371 Date: Jan. 13, 2017

(30) Foreign Application Priority Data
Feb. 11, 2015 (CN) 201510070688.5

(51) Int. Cl. G02B 27/22; G02B 27/00; G02B 5/20

(52) U.S. Cl. CPC G02B 27/225; G02B 5/20; G02B 27/0025

(57) ABSTRACT

The present disclosure provides a display panel for glassless-type 3D display and an electronic device. The display panel includes an array substrate on which a plurality of rows of subpixels is arranged. The subpixels in each row include a first subpixel sequence and a second subpixel sequence arranged adjacent to each other in a row direction and corresponding to different views. The first subpixel sequence and the second subpixel sequence each include one subpixel or a plurality of subpixels arranged consecutively in the row direction. The first subpixel sequence is separated from the second subpixel sequence at a distance greater than or equal to a predetermined threshold in the row direction.

### CROSS-REFERENCE TO RELATED APPLICATION

The present application claims a priority of the Chinese patent application No. 201510070688.5 filed on Feb. 11, 2015, which is incorporated herein by reference in its entirety.

### TECHNICAL FIELD

The present disclosure relates to the field of display technology, in particular to a display panel and an electronic device.

### BACKGROUND

A current stereoscopic (i.e., three-dimensional (3D)) display technology may be essentially classified into a glass-type technology, a head-mount display technology and a glassless-type technology. There are various types of the glassless-type technology, and typically it may include a Lens array technology and a Parallax Barrier technology.

A glassless-type 3D display system mainly includes a two-dimensional (2D) display device (including a liquid crystal display device, a plasma display device, a field-emission display device or an organic electroluminescent display device) and a beam splitter (e.g., a grating). The used grating may be classified into a slit grating and a cylindrical grating.

However, serious crosstalk may occur for the exiting glassless-type display system, and as a result, a depth of field and a stereoscopic effect of a 3D image may be adversely affected.

### SUMMARY

An object of the present disclosure is to provide a display panel and an electronic device, so as to reduce the crosstalk for a 3D display system.

In one aspect, the present disclosure provides in some embodiments a display panel for glassless-type 3D display, including an array substrate on which a plurality of rows of subpixels is arranged. The subpixels in each row include a first subpixel sequence and a second subpixel sequence arranged adjacent to each other in a row direction and corresponding to different views. The first subpixel sequence and the second subpixel sequence each include one subpixel or a plurality of subpixels arranged consecutively in the row direction. The first subpixel sequence is separated from the second subpixel sequence by a gap in the row direction, and a value of a width of the gap is a predetermined threshold.

Optionally, the predetermined threshold is greater than a distance between adjacent subpixels in the subpixel sequence.

Optionally, the predetermined threshold is smaller than or equal to a width of one subpixel.

Optionally, the plurality of rows of subpixels comprises first subpixel rows and second subpixel rows arranged alternately, each of the first subpixel rows is staggered relative to each of the second subpixel rows in the row direction, so that a subpixel in a first color and an adjacent second subpixel in a second color in the first subpixel row are capable of forming a triangular pixel together with a third subpixel in a third color in the second subpixel row, and a subpixel in the first color and an adjacent second subpixel in the first color in the second subpixel row are capable of forming another triangular pixel together with a third subpixel in the third color in the first subpixel row.

Optionally, the first subpixel row is staggered relative to the second subpixel row in the row direction by a distance equal to half of the width of the subpixel.

Optionally, the display panel further includes a color filter substrate on which a black matrix is arranged.

Optionally, the gap is completely located within an orthogonal projection of the black matrix onto a plane where the plurality of rows of subpixels is located.

In another aspect, the present disclosure provides in some embodiments a display device including the above-mentioned display panel.

In yet another aspect, the present disclosure provides in some embodiments a display panel for glassless-type 3D display, including an array substrate on which a plurality of rows of subpixels is arranged. The subpixels in each row include a first subpixel sequence and a second subpixel sequence arranged adjacent to each other in a row direction and corresponding to different views. The first subpixel sequence and the second subpixel sequence each include one pixel or a plurality of subpixels arranged consecutively in the row direction. The display panel further includes at least one opaque shielding unit. An orthogonal projection of the shielding unit onto a plane where the plurality of rows of subpixels is located within a first region occupied by the first subpixel sequence and/or a second region occupied by the second subpixel sequence, and a first portion of the first region not overlapping the orthogonal projection by a gap in the row direction, and a value of a width of the gap is greater than a predetermined threshold.

Optionally, the predetermined threshold is smaller than or equal to a width of one subpixel.

Optionally, the display panel further includes a color filter substrate on which the shielding unit is arranged.

Optionally, the shielding unit is formed simultaneously with a black matrix on the color filter substrate.

Optionally, the plurality of rows of subpixels comprises first subpixel rows and second subpixel rows arranged alternately, and each of the first subpixel rows is staggered relative to each of the second subpixel rows in the row direction, so that a subpixel in a first color and an adjacent second subpixel in the first color in the first subpixel row are capable of forming a triangular pixel together with a third subpixel in a third color in the second subpixel row, and a subpixel in the first color and an adjacent second subpixel in the first color in the second subpixel row are capable of forming another triangular pixel together with a third subpixel in the third color in the first subpixel row.

In still yet another aspect, the present disclosure provides in some embodiments a display device including the above-mentioned display panel.

According to the embodiments of the present disclosure, through changing the gap between the first subpixel sequence and the second subpixel sequence arranged adjacent to each other in the row direction and corresponding to different views, it is able to ensure a value of the width of the gap between visible portions of the subpixel sequences corresponding to different views to be greater than the predetermined threshold, thereby to reduce the crosstalk between the adjacent views.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a schematic view showing relative position relationship between subpixel sequences for a display panel according to one embodiment of the present disclosure;

FIG. 2A is a schematic view showing the crosstalk in the case that the subpixel sequences corresponding to different views are separated from each other at a first distance;

FIG. 2B is a schematic view showing the crosstalk in the case that the subpixel sequences corresponding to different views are separated from each other at a larger distance;

FIGS. 3A and 3B are schematic views showing relative position relationship among a first subpixel sequence, a second subpixel sequence and a black matrix according to one embodiment of the present disclosure;

FIG. 4A is a schematic view showing an arrangement mode of adjacent subpixel rows, where the adjacent subpixel rows are arranged parallel to each other, with both ends of each subpixel row being flush with respective ends of the other subpixel row;

FIG. 4B is a schematic view showing another arrangement mode of the adjacent subpixel rows, where the adjacent subpixel rows are arranged parallel to each other but staggered relative to each other;

FIGS. 5A to 5F are schematic views showing isolation zones for the display panel corresponding to different arrangement modes according to one embodiment of the present disclosure;

FIG. 6A is a schematic view showing an arrangement mode where the subpixels in the subpixel rows are staggered from each other in a direction perpendicular to a row direction according to one embodiment of the present disclosure;

FIG. 6B is a schematic view showing isolation zones for the display panel in the case that the subpixels in the subpixel rows are staggered from each other in the direction perpendicular to the row direction according to one embodiment of the present disclosure;

FIG. 6C is another schematic view showing isolation zones for the display panel in the case that the subpixels in the subpixel rows are staggered from each other in the direction perpendicular to the row direction according to one embodiment of the present disclosure; and

FIGS. 7A to 7C are schematic views showing relative position relationship between a shielding unit of the display panel and the first and second subpixel sequences according to one embodiment of the present disclosure.

### DETAILED DESCRIPTION OF THE EMBODIMENTS

The present disclosure will be described hereinafter in conjunction with the drawings and embodiments. The following embodiments are for illustrative purposes only, but shall not be used to limit the scope of the present disclosure.

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “a” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

In the following, it is clearly and completely described the technical solutions according to the embodiments of the present disclosure. It is obvious that the described embodiments are merely some of all the embodiment of the present disclosure instead of all the embodiments, and based on these embodiments, a person skilled in the art may obtain the other embodiments, which also fall within the scope of the present disclosure.

According to a display panel and an electronic device in the embodiments of the present disclosure, a distance between subpixel sequences for different views is greater than a predetermined threshold, so as to reduce the crosstalk between the adjacent views.

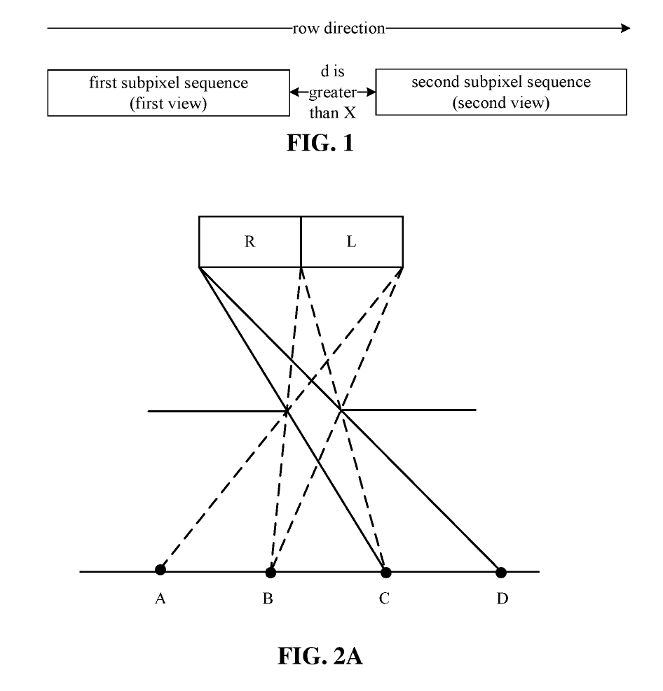

As shown in FIG. 1, the present disclosure provides in some embodiments a display panel for glassless-type 3D display, which includes an array substrate on which a plurality of rows of subpixels is arranged. The subpixels in each row include a first subpixel sequence 101 and a second subpixel sequence 102 arranged adjacent to each other in a row direction and corresponding to different views. The first subpixel sequence 101 and the second subpixel sequence 102 each include one subpixel or a plurality of subpixels arranged consecutively in the row direction. The first subpixel sequence 101 is separated from the second subpixel sequence 102 at a distance greater than or equal to a predetermined threshold in the row direction.

Usually, the display panel may include the array substrate on which a plurality of rows of subpixels is arranged. Regardless of arrangement modes, during the 3D display process, the subpixels in each row (the rows of the subpixels may be arranged in a manner that both ends of each row are in flush with respective ends of the other rows, or the rows of the subpixels may be staggered from each other, which will be described hereinafter in more details) may include a plurality of subpixel sequences arranged in order. The subpixels in each subpixel sequence may correspond to a respective view, and the adjacent subpixel sequences may correspond to different views.

Hence, a maximum distance between the adjacent subpixel sequences in the row direction (e.g., a gap between a last subpixel of the first subpixel sequence and a first subpixel of the adjacent second subpixel sequence) is approximately equal to a width of a data line, and this distance may almost be omitted relative to a width of a pixel.

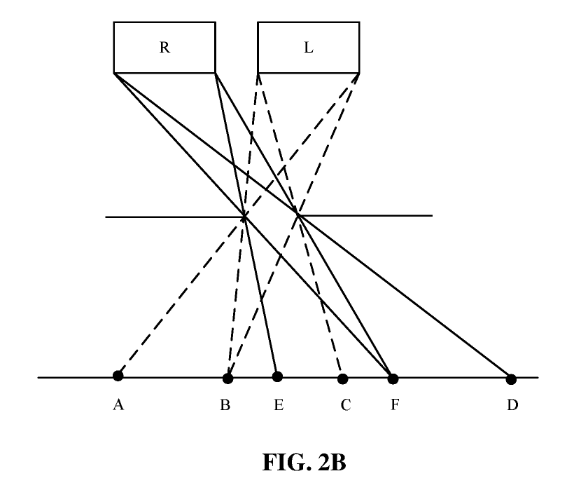

As shown in FIG. 2A, a two-view situation is taken as an example, where R represents the subpixel sequence (including one subpixel or a plurality of adjacent subpixels) corresponding to a right-eye view, and L represents the subpixel sequence (including one subpixel or a plurality of adjacent subpixels) corresponding to a left-eye view. At a region AB, merely the left-eye view may be observed, and at a region CD, merely the right-eye view may be observed. However, at a region BC, both the left-eye view and the right-eye view may be observed simultaneously, i.e., the crosstalk may occur for the region BC.

In the case that a distance between R and L increases, the resultant situation will be described hereinafter, wherein for convenience, merely R is moved to the left, while the others remain in their original places.

As shown in FIG. 2B, since L remains in its original place, the left-eye view may still be observed at a region ABEC, while the right-eye view may be observed at a region ECFD. As compared with FIG. 2A, it is equivalent to that the region where the right-eye view may be observed is moved to the right, so a region where both the left-eye view and the right-eye may be observed is changed from the region BC to a region EC.

It is found that, in the case that the distance between the subpixel sequences corresponding to different views increases, the region where the left-eye view and the right-eye view may be observed simultaneously, i.e., the region where the crosstalk may occur, is reduced.

However, as shown in FIG. 1, for the display panel and electronic device in the embodiments of the present disclosure, the first subpixel sequence 101 and the second subpixel sequence 102 corresponding to different views may be separated in the row direction from each other at a distance greater than or equal to the predetermined threshold. Hence, in the embodiments of the present disclosure, in conjunction with the arrangement mode of the subpixels, it is able to increase the distance (i.e. a width of a gap) between the subpixel sequences corresponding to different views as compared with the related art where the subpixel sequences are separated from each other approximately at a distance equal to the width of the data line, thereby to, as mentioned hereinabove, reduce the crosstalk.

As mentioned above, in the embodiments of the present disclosure, the distance between the adjacent subpixel sequences corresponding to different views in an identical row (i.e., the first subpixel sequence 101 and the second subpixel sequence 102 in FIG. 1) is greater than the predetermined threshold. As long as the predetermined threshold is greater than a distance between the subpixels in each subpixel sequence, it is able to ensure the distance between the adjacent subpixel sequences corresponding to different views for the display panel in the embodiments of the present disclosure to be greater than the distance between the adjacent subpixel sequences corresponding to different views for the display panel in the related art, thereby to reduce the crosstalk.

Hence, in the embodiments of the present disclosure, the predetermined threshold may be greater than the distance between the adjacent subpixels in each subpixel sequence.

The distances between the adjacent subpixels (i.e., distances between two adjacent sides of the adjacent subpixels) may be different from each other. In the embodiments of the present disclosure, in the case that the distance between the adjacent subpixels in each subpixel sequence is less than the width of one subpixel, the distance between the adjacent subpixel sequences may be equal to the width of one subpixel, so as to balance reduction of the crosstalk and the resolution of the display.

For the display panel in the embodiments of the present disclosure, the distance between the subpixel sequences in an identical row corresponding to different views may increase, as compared with the display panel in the related art. In the case that the display panel further includes a color filter substrate on which a black matrix is arranged, the gap between the first subpixel sequence and the second subpixel sequence may be completely located within an orthogonal projection of the black matrix onto a plane where the plurality of rows of subpixels is located, so as to prevent the light leakage due to the larger distance therebetween.

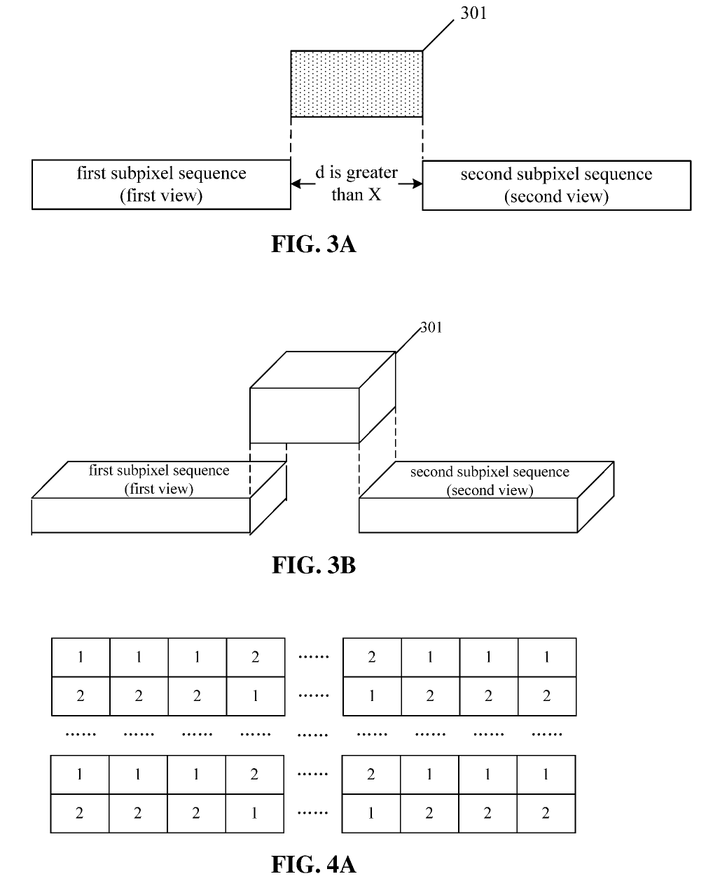

As shown in FIGS. 3A and 3B, which are schematic views showing relative position relationship among the first subpixel sequence, the second subpixel sequence and the black matrix according to one embodiment of the present disclosure, the black matrix 301 is arranged above the isolation zone between the first subpixel sequence and the second subpixel sequence, so as to prevent the light leakage caused by the larger distance between the first subpixel sequence and the second subpixel sequence, thereby to improve the product quality.

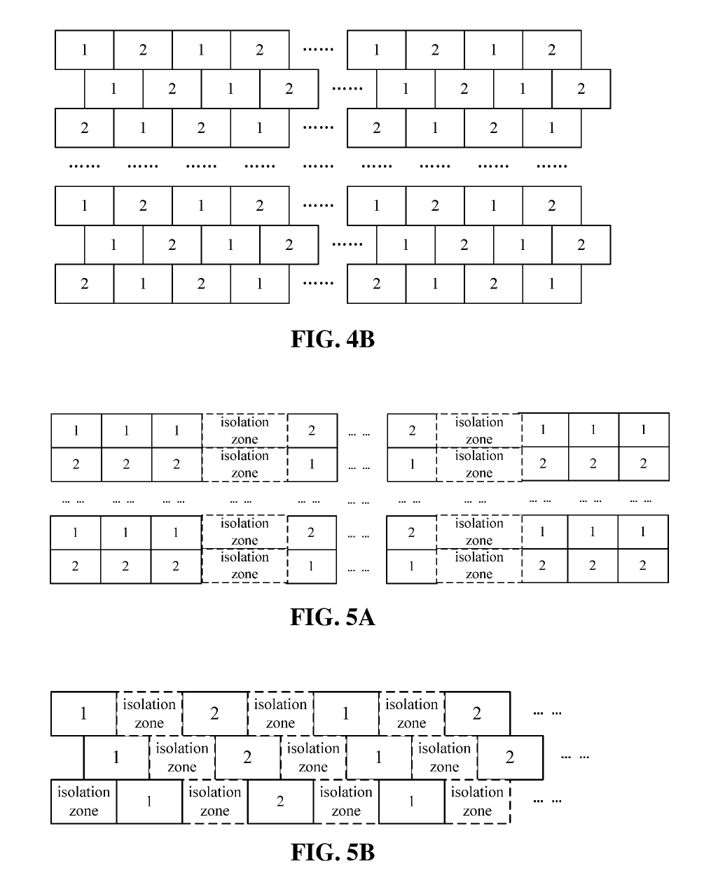

In the case that the subpixels in each subpixel row are arranged in a strip form (i.e., the subpixels are aligned with each other in each subpixel row), the adjacent subpixel rows may be arranged in the following two modes. As shown in FIG. 4A, the adjacent subpixel rows may be arranged parallel to each other, with both ends of each subpixel row being flush with respective ends of the other subpixel row, and as shown in FIG. 4B, the adjacent subpixel rows may be arranged parallel to each other but staggered relative to each other.

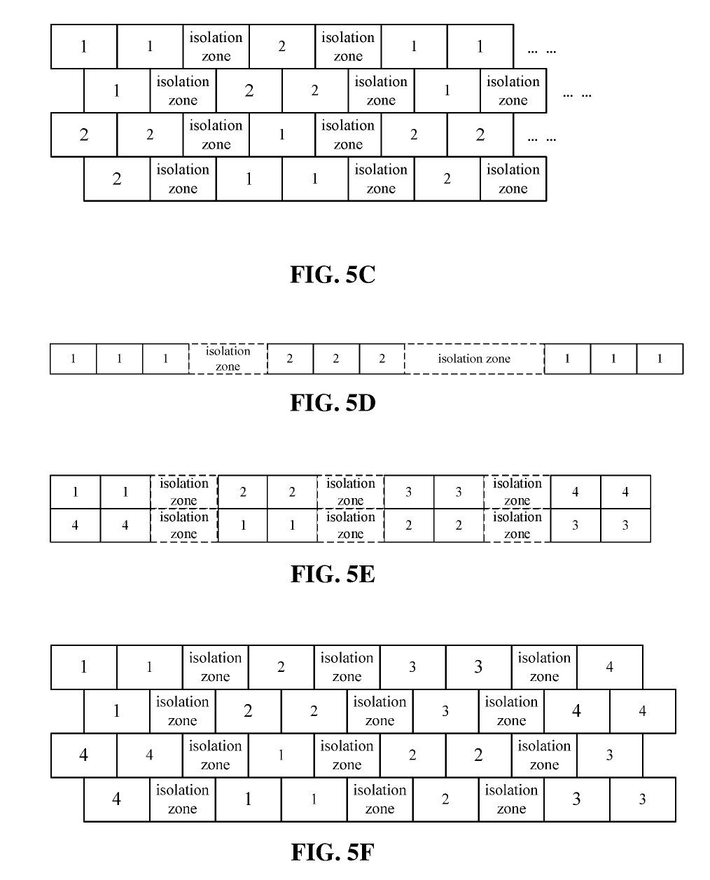

In FIG. 4A, each subpixel sequence may include three subpixels, and the adjacent subpixel sequences may correspond to different views. FIG. 5A shows an arrangement mode for the subpixels.

As shown in FIG. 5A, in the array substrate, an isolation zone is provided between the adjacent subpixel sequences (each including a plurality of subpixels) corresponding to different views, i.e., the adjacent subpixel sequences corresponding to different views are separated from each other at a certain distance, so as to further increase, as compared with the related art, the distance between the adjacent subpixel sequences corresponding to different views in the display panel, thereby to reduce the crosstalk for the 3D display.

It is found that, in FIG. 4B, each subpixel sequence may include one subpixel, and the adjacent subpixel sequences may correspond to different views. FIG. 5B shows such arrangement mode for the subpixels.

As shown in FIG. 5B, in the display panel, an isolation zone is provided between the adjacent subpixel sequences (each including one subpixel) corresponding to different views, i.e., the adjacent subpixel sequences corresponding to different views are separated from each other at a certain distance, so as to increase, as compared with the related art, the distance between the adjacent subpixel sequences corresponding to different views in the display panel, thereby to reduce the crosstalk for the 3D display.

As shown in FIG. 5B, the three subpixels in an oblique direction may form a pixel.

FIG. 5C shows another arrangement mode for the subpixels in the case that the subpixel rows are staggered relative to each other in the embodiments of the present disclosure.

FIG. 5C is same as FIG. 5B in that the isolation zone is provided between the adjacent subpixel sequences (each including one subpixel) in an identical row corresponding to different views, and FIG. 5C is different from FIG. 5B in that the three subpixels in a triangular arrangement form a triangular pixel in FIG. 5C.

It is found that, for the array substrate in the embodiments of the present disclosure, the isolation zone with a certain width is provided between any adjacent subpixel sequences corresponding to different views, so that the distance between the any adjacent subpixel sequences is at least greater than the predetermined threshold.

In the embodiments of the present disclosure, the width of the isolation zone between the adjacent subpixel sequences corresponding to different views will not be particularly defined, and the widths of the isolation zones may be identical, as shown in FIG. 5D, or different from each other.

Although the above description is given on the basis of the two-view situation, the array substrate in the embodiments of the present disclosure may also be applied to the situation where N (N is greater than or equal to 3) views are displayed simultaneously, which will be described hereinafter in more details.

An N-view 3D display system (N is greater than or equal to 3) differs from the two-view 3D display system in the number of the views. However, for the subpixels in each row, they may be distributed identically, i.e., the subpixels in each row may be divided into a plurality of subpixel sequences corresponding to different views. Each subpixel sequence may correspond to an identical view, while the adjacent subpixel sequences may correspond to different views. For the display panel in the embodiments of the present disclosure, an isolation zone with a width greater than the predetermined threshold may be provided between any adjacent subpixel sequences corresponding to different views, such that the distance between any adjacent subpixel sequences corresponding to different views is greater than a predetermined threshold, and thereby to reduce the crosstalk.

A four-view display process will be described hereinafter in the case that both ends of each subpixel row is in flush with the respective ends of the adjacent subpixel row or each subpixel row is staggered from the adjacent subpixel row.

FIG. 5E is a schematic view showing the arrangement mode for the subpixels of an array substrate for the four-view display system in the case that both ends of each subpixel row is in flush with the respective ends of the adjacent subpixel row in the embodiments of the present disclosure. An isolation zone (e.g. a gap) with a width greater than the predetermined threshold may be provided between the subpixel sequences corresponding to different views, such that the distance between any adjacent subpixel sequences corresponding to different views is greater than a predetermined threshold, and thereby to reduce the crosstalk.

FIG. 5F is a schematic view showing the arrangement mode for the subpixels of an array substrate for the four-view display system in the case that each subpixel row is staggered from the adjacent subpixel row in the embodiments of the present disclosure. An isolation zone with a width greater than the predetermined threshold may be provided between the subpixel sequences corresponding to different views, such that the distance between any adjacent subpixel sequences corresponding to different views is greater than a predetermined threshold, and thereby to reduce the crosstalk.

As shown in FIGS. 4B, 5B and 5C, in the embodiments of the present disclosure, the plurality of rows of subpixels includes first subpixel rows and second subpixel rows arranged alternately, each first subpixel row is staggered relative to the each second subpixel row in the row direction, so that a subpixel in a first color and an adjacent second subpixel in the first color in the first subpixel row are capable of forming a triangular pixel together with a third subpixel in a third color in the second subpixel row, and a subpixel in the first color and an adjacent second subpixel in the second color in the second subpixel row are capable of forming another triangular pixel together with a third subpixel in the third color in the first subpixel row.

In the embodiments of the present disclosure, in the case that the first subpixel row is staggered from the second subpixel row in the row direction by a distance equal to half of the width of the subpixel, it is able to ensure central points of all the resultant triangular pixels to be distributed evenly, thereby to ensure the display evenness.

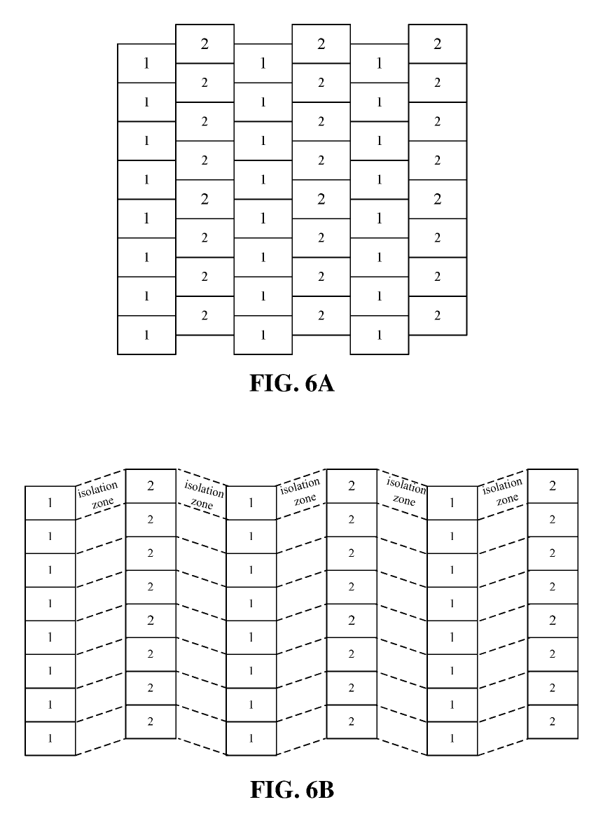

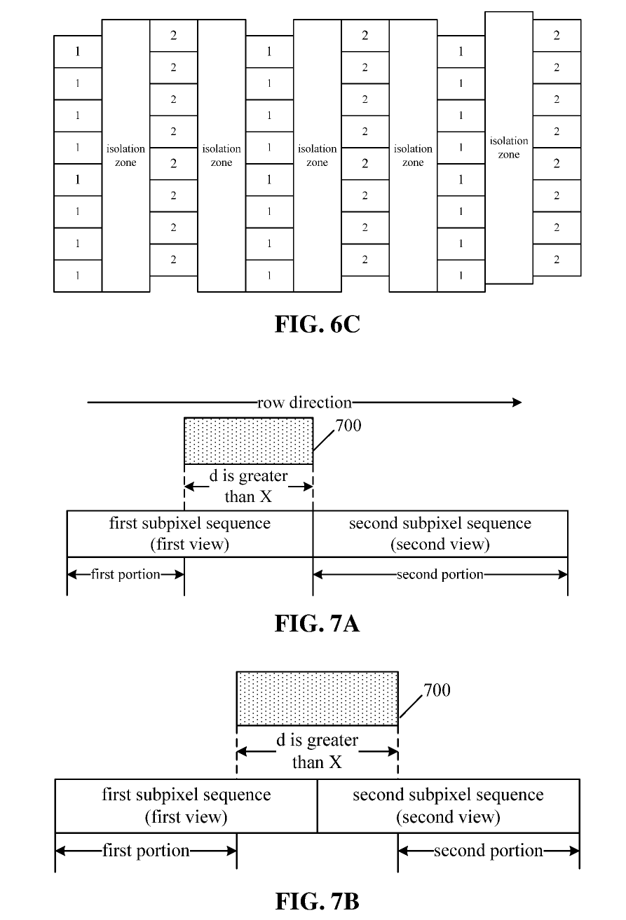

The arrangement modes for the subpixels have been described hereinabove in the case that the subpixels in each subpixel row in the array substrate are arranged in a strip form. However, the subpixels in each subpixel row may also be staggered from each other in a direction perpendicular to the row direction, as shown in FIG. 6A.

Different from FIGS. 4A-5F, in FIG. 6A, the subpixels in each subpixel row may also be staggered from each other in the direction perpendicular to the row direction. At this time, as shown in FIGS. 6B and 6C, an isolation zone with a width greater than the predetermined threshold may also be provided between the adjacent subpixel sequences corresponding to different views, such that the distance between any adjacent subpixel sequences corresponding to different views is greater than a predetermined threshold, and thereby to reduce the crosstalk.

In FIG. 6B, the two-view situation is taken as an example. Of course, the embodiments of the present disclosure may also be similarly applied to the display panel where N (N is greater than or equal to 3) views are displayed simultaneously, which will not be particularly defined herein.

The present disclosure further provides in some embodiments a display device including the above-mentioned display panel.

The display device in the embodiments of the present disclosure may be any product or member having a display function, such as a liquid crystal panel, a mobile phone, a flat-panel computer, a television, a display, a laptop computer, a digital photo frame or a navigator. The implementation of the display device may refer to that of the display panel mentioned above, and thus will not be particularly defined herein.

According to the embodiments of the present disclosure, it is able to reduce the crosstalk by setting the distance between the adjacent subpixel sequences for displaying different views. It should be appreciated that, through setting a larger distance between the adjacent subpixel sequences, a distance between edges of the adjacent subpixel sequences that are capable of being observed by a user, may increase. Such increase may also be achieved by a shielding module, which will be described hereinafter in more details.

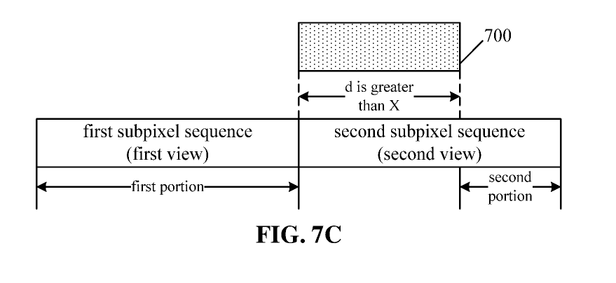

The present disclosure further provides in some embodiments another display panel for glassless-type 3D display, which includes an array substrate on which a plurality of rows of subpixels is arranged. The subpixels in each row include a first subpixel sequence and a second subpixel sequence arranged adjacent to each other in the row direction and corresponding to different views. The first subpixel sequence and the second subpixel sequence each include one pixel or a plurality of subpixels arranged consecutively in the row direction. As shown in FIGS. 7A-7C, the display panel may further include at least one opaque shielding unit 700. An orthogonal projection of the shielding unit onto a plane where the plurality of rows of subpixels is located within a first region occupied by the first subpixel sequence and/or a second region occupied by the second subpixel sequence, and a first portion of the first region not overlapping the orthogonal projection is separated from a second portion of the second region not overlapping the orthogonal projection at a distance greater than a predetermined threshold in the row direction.

As shown in FIG. 7A, the orthogonal projection of the shielding unit onto the plane where the plurality of rows of subpixels is completely located within the first region. As shown in FIG. 7B, a portion of the orthogonal projection of the shielding unit onto the plane where the plurality of rows of subpixels is located within the first region, while the remaining portion is located within the second region. As shown in FIG. 7C, the orthogonal projection of the shielding unit onto the plane where the plurality of rows of subpixels is completely located within the second region.

In any cases, the distance between the first portion of the first region not overlapping the orthogonal projection and the second portion of the second region not overlapping the orthogonal projection in the row direction is greater than the predetermined threshold.

In other words, through setting the shielding unit, it is able to ensure that a portion of at least one of the first subpixel sequence and the second subpixel sequence arranged adjacent to each other in the row direction and corresponding to different views is shielded by the shielding unit, and meanwhile the distance between the unshielded portions that may be observed by the user is greater than the predetermined threshold.

Thus, merely the unshielded portions may be observed by the user, i.e., the distance between the portions of the subpixel sequences, which correspond to different views and which may be observed by the user, increases, and as a result, it is able to reduce the crosstalk.

In the embodiments of the present disclosure, the predetermined threshold is greater than a distance between the adjacent subpixels in each subpixel sequence. However, generally it is able to remarkably reduce the crosstalk in the case that the distance between the adjacent subpixel sequences is equal to a width of one subpixel.

In the embodiments of the present disclosure, the shielding unit may be arranged separately. However, in order to reduce the production cost, it may also be arranged on the color filter and formed simultaneously with a black matrix on the color filter substrate.

As mentioned above, the subpixel rows may also be staggered relative to each other. To be specific, the plurality of rows of subpixels includes first subpixel rows and second subpixel rows arranged alternately, each first subpixel row is staggered relative to the each second subpixel row in the row direction, so that a subpixel in a first color and an adjacent second subpixel in the first color in the first subpixel row are capable of forming a triangular pixel together with a third subpixel in a third color in the second subpixel row, and a subpixel in the first color and an adjacent second subpixel in the first color in the second subpixel row are capable of forming another triangular pixel together with a third subpixel in the third color in the first subpixel row.

The present disclosure further provides in some embodiments a display device including the above-mentioned display panel.

The display device in the embodiments of the present disclosure may be any product or member having a display function, such as a liquid crystal panel, a mobile phone, a flat-panel computer, a television, a display, a laptop computer, a digital photo frame or a navigator. The implementation of the display device may refer that of the display panel mentioned above, which will not be particularly defined herein.

The above are merely the preferred embodiments of the present disclosure. Obviously, a person skilled in the art may make further modifications and improvements without departing from the spirit of the present disclosure, and these modifications and improvements shall also fall within the scope of the present disclosure.

1. A display panel for glassless-type three-dimensional (3D) display, comprising an array substrate on which a plurality of rows of subpixels is arranged, wherein
the subpixels in each row comprise a first subpixel sequence and a second subpixel sequence arranged adjacent to each other in a row direction, and the first subpixel sequence and the second subpixel sequence corresponds to different views respectively;
each subpixel sequence of the first subpixel sequence and the second subpixel sequence comprises one subpixel or a plurality of subpixels arranged consecutively in the row direction; and
the first subpixel sequence is separated from the second subpixel sequence by a gap in the row direction, and a value of a width of the gap is a predetermined threshold.

2. The display panel according to claim 1, wherein the predetermined threshold is greater than a distance between adjacent subpixels in the subpixel sequence.

3. The display panel according to claim 2, wherein the predetermined threshold is smaller than or equal to a width of one subpixel.

4. The display panel according to claim 1, wherein the plurality of rows of subpixels comprises first subpixel rows and second subpixel rows arranged alternately, each of the first subpixel rows is staggered relative to each of the second subpixel rows in the row direction, so that a subpixel in a first color and an adjacent second subpixel in the first color in the first subpixel row are capable of forming a triangular pixel together with a third subpixel in a third color in the second subpixel row, and a subpixel in the first color and an adjacent second subpixel in the first color in the second subpixel row are capable of forming another triangular pixel together with a third subpixel in the third color in the first subpixel row.

5. The display panel according to claim 4, wherein the first subpixel row is staggered relative to the second subpixel row in the row direction by a distance equal to half of a width of the subpixel.

6. The display panel according to claim 1, further comprising a color filter substrate on which a black matrix is arranged.

7. The display panel according to claim 6, wherein the gap is completely located within an orthogonal projection of the black matrix onto a plane where the plurality of rows of subpixels is located.

8. A display device comprising the display panel according to claim 1.

9. A display panel for glassless-type three-dimensional (3D) display, comprising an array substrate on which a plurality of rows of subpixels is arranged, wherein
the subpixels in each row comprise a first subpixel sequence and a second subpixel sequence arranged adjacent to each other in a row direction, and the first subpixel sequence and the second subpixel sequence correspond to different views respectively;
each subpixel sequence of the first subpixel sequence and the second subpixel sequence comprises one subpixel or a plurality of subpixels arranged consecutively in the row direction;
the display panel further comprises at least one opaque shielding unit;
an orthogonal projection of the shielding unit onto a plane where the plurality of rows of subpixels is located within a first region occupied by the first subpixel sequences, a second region occupied by the second subpixel sequences, or the first region and the second region; and
a first portion of the first region not overlapping the orthogonal projection is separated from a second portion of the second region not overlapping the orthogonal projection by a gap in the row direction, and a value of a width of the gap is greater than a predetermined threshold.

10. The display panel according to claim 9, wherein the predetermined threshold is greater than a distance between adjacent subpixels in the subpixel sequence.

11. The display panel according to claim 9, further comprising a color filter substrate on which the shielding unit is arranged.

12. The display panel according to claim 11, wherein the shielding unit is formed simultaneously with a black matrix on the color filter substrate.

13. The display panel according to claim 9, wherein the plurality of rows of subpixels comprises first subpixel rows and second subpixel rows arranged alternately, and each of the first subpixel rows is staggered relative to each of the second subpixel rows in the row direction, so that a subpixel in a first color and an adjacent second subpixel in the first color in the first subpixel row are capable of forming a triangular pixel together with a third subpixel in a third color in the second subpixel row, and a subpixel in the first color and an adjacent second subpixel in the first color in the second subpixel row are capable of forming another triangular pixel together with a third subpixel in the third color in the first subpixel row.

14. A display device comprising the display panel according to claim 9.

15. The display panel according to claim 2, wherein the plurality of rows of subpixels comprises first subpixel rows and second subpixel rows arranged alternately, each of the first subpixel rows is staggered relative to each of the second subpixel rows in the row direction, so that a subpixel in a first color and an adjacent second subpixel in the first color in the first subpixel row are capable of forming a triangular pixel together with a third subpixel in a third color in the second subpixel row, and a subpixel in the first color and an adjacent second subpixel in the first color in the second subpixel row are capable of forming another triangular pixel together with a third subpixel in the third color in the first subpixel row.

16. The display panel according to claim 3, wherein the plurality of rows of subpixels comprises first subpixel rows and second subpixel rows arranged alternately, each of the first subpixel rows is staggered relative to each of the second subpixel rows in the row direction, so that a subpixel in a first color and an adjacent second subpixel in the first color in the first subpixel row are capable of forming a triangular pixel together with a third subpixel in a third color in the second subpixel row, and a subpixel in the first color and an adjacent second subpixel in the first color in the second subpixel row are capable of forming another triangular pixel together with a third subpixel in the third color in the first subpixel row.

17. The display device according to claim 8, wherein the predetermined threshold is greater than a distance between adjacent subpixels in the subpixel sequence.

18. The display device according to claim 17, wherein the predetermined threshold is smaller than or equal to a width of one subpixel.

19. The display device according to claim 14, wherein the predetermined threshold is greater than a distance between adjacent subpixels in the subpixel sequence.

20. The display device according to claim 14, wherein the display panel further comprises a color filter substrate on which the shielding unit is arranged.
